(19) United States
(12) Patent Application Publication
(10) Pub. No.: US 2020/0104857 A1
(43) Pub. Date: Apr. 2, 2020

(54) SYSTEM AND METHOD FOR TRACKING STATUS OF LEADS GENERATED THROUGH ONLINE ADVERTISEMENTS

(71) Applicant: Nistala Srinivas RAMESH, SINGAPORE (SG)

(72) Inventor: Nistala Srinivas RAMESH, SINGAPORE (SG)

(21) Appl. No.: 16/148,996

(22) Filed: Oct. 1, 2018

(51) Int. Cl. G06Q 30/00; G06Q 30/02

(52) U.S. Cl. CPC G06Q 30/01; G06Q 30/0246; G06Q 30/0277

(57) ABSTRACT

A computer-implemented method and system for tracking of leads generated through online advertisements in real time includes a first step of associating plural advertisement platforms of plural publishers with a tracking system. The method includes another step of integrating customer management platforms of plural advertisers with the tracking system. The method also includes classifying stages in a conversion process of leads generated through the online advertisements. The method also includes tracking the status of the leads generated through the online advertisements in view of the stages in the conversion process. The tracking system tracks status of the leads generated through the online advertisements against a unique identification number.

### TECHNICAL FIELD

The present invention relates to a field of advertising, and in particular, provides a system and method for dynamic and real time status tracking of leads generated through online advertisements.

### Introduction

In recent years, advertising over more interactive online media platforms has become increasingly popular. The interactive online media platform corresponds to websites, webpages, applications, social media platforms and the like. The advertising space includes three main entities i.e. advertisers, publishers and end users. An advertiser is associated with various publishers for providing advertisements of products and services to end users. The advertisers provide advertisements of goods and services to increase sale of the goods and services. The publishers display advertisement on online platforms in exchange of revenue. The end users click on advertisements published on online platforms of the publishers and are redirected as leads to online platform of the advertisers. The advertisers pay the publishers for generating fruitful leads. The advertisers pay the publisher when a lead is converted into a customer who buys the advertiser's product or service. The advertiser executes a series of pre-defined steps to enable lead conversion process. The advertisers are associated with various lead management platforms to maintain track of the lead conversion process. The publishers are not associated with the lead management platforms. The publishers cannot track status of leads generated through online advertisements. The publishers require status of lead generated for advertiser billing, performance management and various other reasons. The publishers rely on receiving manual inputs from the advertisers for status of lead generated. The manual process introduces communication gap between the advertisers and the publishers. The manual process results in various delays, disintegration and errors. The manual process lacks transparency. The manual process results in invoicing error and invoicing delays.

In light of the above stated discussion, there is a need for a method and system which overcomes the above stated disadvantages.

### SUMMARY

In a first example, a computer implemented method is provided. The computer-implemented method may be configured for tracking status of leads generated through online advertisements on real time dynamic basis. The computer-implemented method may include a first step of associating at least one advertisement platform of a plurality of advertisement platforms with a tracking system. Each of the plurality of advertisement platforms provides space for publishing of online advertisements. Each of the plurality of advertisement platforms is associated with a publisher of a plurality of publishers. The computer-implemented method may include another step of integrating one or more customer management platforms of at least one advertiser of a plurality of advertisers. The one or more customer management platforms facilitate in management of a conversion process of leads generated through online advertisements. The computer-implemented method may include yet another step of classifying one or more stages in the conversion process of leads generated through online advertisements. The classification of the one or more stages in the conversion process of leads generated through online advertisements is updated in real time. The computer-implemented method may include yet another step of tracking status of leads generated through online advertisements in view of the one or more stages in the conversion process. The tracking system tracks status of leads generated through online advertisements against a unique identification number. The tracking system enables the plurality of publishers associated with corresponding advertisement platform of the plurality of advertisement platform to track status of leads generated through online advertisements in real time. In an embodiment of the present disclosure, the computer-implemented method includes yet another step of assigning at the tracking system the unique identification number to each of one or more users performing a click of a plurality of click by one or more users on the online advertisements. The tracking system stores details of each advertisement platform and publishers against each click and the corresponding unique identification number.

In an embodiment of the present disclosure, the tracking system with the processor updates corresponding publisher of the plurality of publishers on progress of leads generated through online advertisements in the one or more stages of the conversion process.

In an embodiment of the present disclosure, the plurality of advertisement platforms of the plurality of publishers includes a publisher website, a publisher application and a publisher e-mail.

In an embodiment of the present disclosure, the one or more customer management platforms of the plurality of advertisers include customer relationship management system, a website and an application.

In an embodiment of the present disclosure, the tracking system enables the plurality of publishers to assess performance of advertisements to enable performance based advertisements.

In an embodiment of the present disclosure, the classification of the one or more stages in the conversion process is enabled with assent of corresponding publisher of the plurality of publishers and corresponding advertiser of the plurality of advertisers. The classification of the one or more stages in the conversion process of leads generated through online advertisements is updated with assent of corresponding publisher of the plurality of publishers and the corresponding advertiser of the plurality of advertisers.

In an embodiment of the present disclosure, the tracking system facilitates corresponding publisher of the plurality of publishers to precisely bill corresponding advertiser of the plurality of advertisers.

In an embodiment of the present disclosure, the tracking system enables each of the plurality of advertisers to attribute leads generated through online advertisements to corresponding publisher of the plurality of publishers.

In a second example, a computer system is provided. The computer system may include one or more processors and a memory coupled to the one or more processors. The memory may store instructions which, when executed by the one or more processors, may cause the one or more processors to perform a method. The method is configured for tracking status of leads generated through online advertisements on real time dynamic basis. The method may include a first step of associating a plurality of advertisement platforms of a plurality of publishers. Each of the plurality of advertisement platforms provides space for publishing of online advertisements. The method may include another step of integrating one or more customer management platforms of a plurality of advertisers. The one or more customer management platforms facilitate in management of a conversion process of leads generated through online advertisements. The method may include yet another step of classifying one or more stages in the conversion process of leads generated through online advertisements. The classification of the one or more stages in the conversion process of leads generated through online advertisements is updated in real time. The method may include yet another step of tracking status of leads generated through online advertisements in view of the one or more stages in the conversion process. The tracking system tracks status of leads generated through online advertisements against a unique identification number. The tracking system enables the plurality of publishers to track status of leads generated through online advertisements in real time.

In a third example, a non-transitory computer readable medium is provided. The non-transitory computer readable medium having instructions stored which are executed by one or more processors to perform a method for tracking status of leads generated through online advertisements on real time dynamic basis. The method may include a first step of associating a plurality of advertisement platforms of a plurality of publishers. Each of the plurality of advertisement platforms provides space for publishing of online advertisements. The method may include another step of integrating one or more customer management platforms of a plurality of advertisers. The one or more customer management platforms facilitate in management of a conversion process of leads generated through online advertisements. The method may include yet another step of classifying one or more stages in the conversion process of leads generated through online advertisements. The classification of the one or more stages in the conversion process of leads generated through online advertisements is updated in real time. The method may include yet another step of tracking status of leads generated through online advertisements in view of the one or more stages in the conversion process. The tracking system tracks status of leads generated through online advertisements against a unique identification number. The tracking system enables the plurality of publishers to track status of leads generated through online advertisements in real time.

### BRIEF DESCRIPTION OF THE FIGURES

Having thus described the invention in general terms, reference will now be made to the accompanying drawings, which are not necessarily drawn to scale, and wherein:

FIG. 1 illustrates an interactive computing environment for tracking of leads generated through online advertisements in real time, in accordance with various embodiments of the present disclosure;

FIG. 2 is a flowchart of a method for tracking of the leads generated through the online advertisements in real time, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

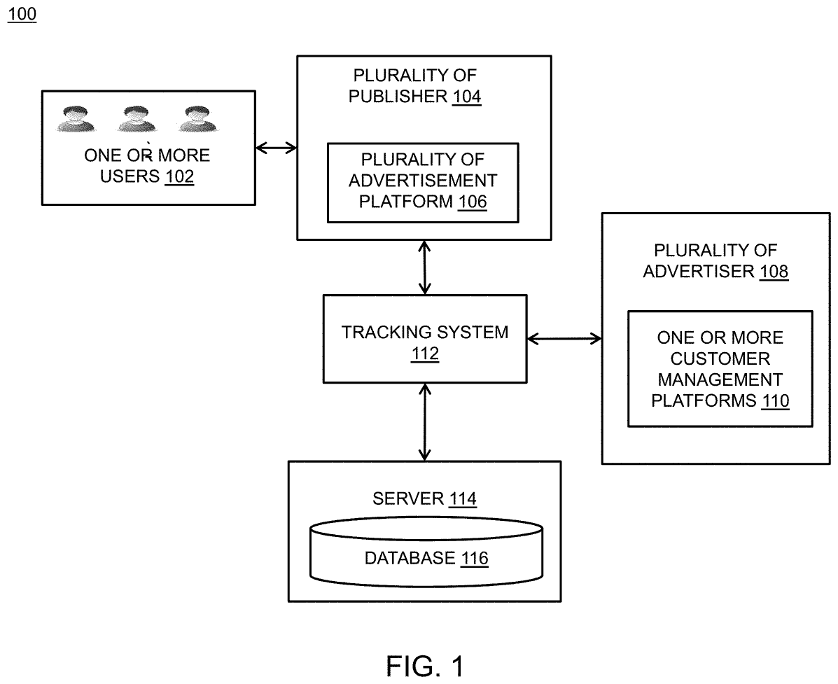

FIG. 1 illustrates an interactive computing environment 100 for tracking of leads generated through online advertisements in real time, in accordance with various embodiment of the present disclosure. The interactive computing environment 100 illustrates an environment suitable for an interactive reception and processing of a multiple channel broadcast. The interactive computing environment 100 is configured to provide a setup for tracking of status of leads generated through online advertisements. The interactive computing environment 100 is configured to enable tracking of leads generated through online advertisements. The interactive computing environment 100 enable publishers to track status of leads generated through online advertisements in real time. The interactive computing environment 100 facilitates to track conversion of leads to ensure validation of leads. The interactive computing environment 100 facilitates in association of advertisement platforms of publishers and customer management platforms of advertisers. The interactive computing environment 100 facilitates in integration of lead management platforms of advertisers.

In general, lead corresponds to a user clicking on a online advertisements published on a digital platform of a publisher. The online advertisements includes content of an advertiser. The content of online advertisements includes one or more products or one or more services offered by the advertiser. The user clicking on the online advertisements of the advertiser exhibits interest in the one or more products or the one or more services. The user clicking on the online advertisements of the advertiser is a lead for the advertiser. The advertiser on capturing of the lead executes steps for validation of the lead. Validation of lead corresponds to whether the lead generated is a potential customer or not, based on various levels or stages of conversion associated with a lead curation process. The advertiser is associated with a digital platform. The digital platform facilitates the advertiser to execute steps for validation of the lead. The digital platform facilitates the advertiser to track validation of the lead.

The interactive computing environment 100 includes one or more users 102 and a plurality of publishers 104 associated with a plurality of advertisement platforms 106. Further, the interactive computing environment 100 includes a plurality of advertisers 108 associated with one or more customer management platforms 110. In addition, the interactive computing environment 100 includes a tracking system 112, a server 114 and a database 116. The above stated elements of the interactive computing environment 100 operate coherently and synchronously to enable tracking of leads generated through online advertisements in real time. The above stated elements of the interactive computing environment 100 collectively enable optimized advertisement budget. In addition, the above stated elements of the interactive computing environment 100 collectively enable optimized inventory management of the product.

The interactive computing environment 100 includes the one or more users 102. The one or more users 102 are associated with the interactive computing environment 100 with facilitation of one or more communication devices. The one or more users 102 access one or more of the plurality of advertisement platforms 106 for one or more purposes. The one or more purpose includes accessing information, data, facts, figures or news. The one or more purpose includes social networking. The one or more purpose includes bill payment. The one or more purpose includes financial transaction. The one or more purpose includes entertainment. The one or more purpose includes online shopping. The one or more purpose includes online booking of tickets, amenities and other services. The one or more purpose includes any suitable purpose of the like. The one or more users 102 access one or more of the plurality of advertisement platforms 106 with facilitation of one or more communication devices. The one or more users 102 encounter advertisements on each of the plurality of advertisement platforms 106. Each of the one or more users 102 clicking on advertisement is a lead generated through online advertisements.

The interactive computing environment 100 includes the plurality of publishers 104. Each of the plurality of publishers 104 is administrator or owner of the plurality of advertisement platforms 106. The plurality of publishers 104 provides space on the plurality of advertisement platforms 106 to the plurality of advertisers 108 to display advertisements. The one or more users 102 encounter advertisements while accessing the plurality of advertisement platforms 106 of the plurality of publishers 104. The advertisements include text advertisements, video advertisements, audio advertisement, banner advertisement, graphic advertisements and the like. In an embodiment of the present disclosure, the advertisements include any suitable advertisement of the like. The plurality of publishers 104 provides space, areas or a part of the plurality of advertisement platforms 106 for advertising purposes. These areas or spaces on the plurality of advertisement platforms 106 are referred to as advertisement slots. The plurality of advertisement platforms 106 can have various advertisement slots depending on choice of corresponding publisher of the plurality of publishers 104.

The interactive computing environment 100 includes the plurality of advertisement platforms 106. Each of the plurality of advertisement platforms 106 is a websites, a webpage or an application. In general, advertisement platform provide space for publishing of one or more advertisements. Each of the plurality of publishers 104 is associated with one or more of the plurality of advertisement platforms 106. The plurality of advertisement platforms 106 include mobile advertisement platform. The plurality of advertisement platforms 106 include internet advertisement platform. In an embodiment of the present disclosure, the plurality of advertisement platforms 106 includes any suitable advertisement platform of the like. The plurality of advertisement platforms 106 of the plurality of publishers 104 includes a publisher website. The plurality of advertisement platforms 106 of the plurality of publishers 104 includes a publisher application. The plurality of advertisement platforms 106 of the plurality of publishers 104 includes a publisher e-mail. In an embodiment of the present disclosure, the plurality of advertisement platforms 106 of the plurality of publishers 104 includes any suitable platform of the like.

The interactive computing environment 100 includes the plurality of advertisers 108. In general, advertiser corresponds to an individual or entity that sells one or more goods or services in return for payment. The plurality of advertisers 108 provides advertisements of the one or more goods or services to generate leads. In general, leads correspond to users clicking on the advertisement of one or more good or service. The one or more users 102 clicking on advertisement provided by an advertiser of the plurality of advertisers 108 are leads for the advertiser of the plurality of advertisers 108. The one or more users 102 clicking on advertisement displayed on one or more of the plurality of advertisement platforms 106 correspond to leads generated through online advertisements. Each of the plurality of advertisers 108 sells various products. The plurality of publishers 104 is associated with the plurality of advertisers 108. The plurality of advertisers 108 provides advertisements to the one or more publishers 114 for displaying on the plurality of advertisement platforms 106. The advertisements are placed on the advertisement slots on the plurality of advertisement platforms 106. The plurality of advertisers 108 purchases advertisement slots from one or more of the plurality of publishers 104.

Each of the one or more users 102 clicking on advertisement displayed on one or more of the plurality of advertisement platforms 106 is redirected to an online platform of corresponding advertiser of the plurality of advertisers 108. Each of the plurality of advertisers 108 enables a conversion process for lead generated through online advertisements. In general, conversion process corresponds to confirming whether lead generated is a prospective lead or not based on various levels or steps of conversion associated with conversion process. Each of the plurality of advertisers 108 enables the conversion process for lead generated through online advertisements for each of the one or more goods or services. The plurality of steps of the conversion process varies with the one or more goods or services. The conversion process is different for each of the plurality of advertisers 108. Each of the plurality of advertisers 108 follow pre-specified conversion process for each of the one or more goods. Each of the plurality of advertisers 108 follows pre-specified conversion process for various services.

The conversion process includes a plurality of steps. The plurality of steps is followed to confirm whether lead generated through online advertisements is a customer or not. The plurality of steps includes submitting personal details by the one or more users 102. The plurality of steps includes submitting a form by the one or more users 102. The plurality of steps includes sending e-mail to the one or more users 102. The plurality of steps includes receiving conformational e-mail from the one or more users 102. The plurality of steps includes sing-up to a service or newsletter by the one or more users 102. The plurality of steps includes downloading an application by the one or more users 102. The plurality of steps includes accepting a meeting invitation by the one or more users 102. The plurality of steps includes confirmation call to the one or more users 102. The plurality of steps includes a transaction by the one or more users 102. The plurality of steps includes any suitable steps of the like. In an embodiment of the present disclosure, the conversion process is enables with facilitation of any suitable mechanism.

The plurality of advertisers 108 purchases advertisement slots on each of the plurality of advertisement platforms 106 under a specific pricing model. The specific pricing model is designed with opinion and assent of the plurality of publishers 104 and the plurality of advertisers 108. The specific pricing model is pre-defined and agreed upon by corresponding advertiser of the plurality of advertisers 108 and corresponding publisher of the plurality of publishers 104. The specific pricing model includes pay-per-action. In general, pay-per-action corresponds to an online advertising model where an advertiser pays to publisher for pre-specified acquisition like a sale, a click, form submit, contact request, newsletter sign up or registration etc. In pay-per-action the plurality of advertisers 108 pays pre-agreed amount to the plurality of publishers 104 in view of undertaken or executed steps of the conversion process. In an embodiment of the present disclosure, the specific pricing model includes any suitable model of the like.

The interactive computing environment 100 includes the one or more customer management platforms 110. Each of the plurality of advertisers 108 is associated with one or more customer management platforms 110. In general, customer management platform corresponds to a platform for managing advertiser interaction with potential customers. The one or more customer management platforms 110 employ data analysis to improve business relationships with the one or more users 102. The one or more customer management platforms 110 focuses on tracking conversion of lead generated through online advertisements. The one or more customer management platforms 110 consolidate data from one or more communication channels to streamline the conversion process. The one or more communication channel enables communication between lead generated through online advertisements and corresponding advertiser of the plurality of advertisers 108. The one or more communication channel facilitates the plurality of advertisers 108 to enable the conversion process.

The one or more customer management platforms 110 include customer relationship management application. The one or more customer management platforms 110 include customer relationship management software. The one or more customer management platforms 110 include a website. The website is a customer relationship management website. The one or more customer management platforms 110 include an application. The application is a customer relationship management application. In an embodiment of the present disclosure, the one or more customer management platforms 110 include software. The software is a customer relationship management software. In an embodiment of the present disclosure, the one or more customer management platforms 110 include any suitable management platform of the like. The one or more communication channel includes website. The one or more communication channel includes personal call. The one or more communication channel includes personal text. The one or more communication channel includes e-mail. The one or more communication channel includes live chat. The one or more communication channel includes marketing materials. The one or more communication channel includes social media.

The interactive computing environment 100 includes the tracking system 112. The tracking system 112 enables tracking of status of leads generated through online advertisements. The tracking system 112 is configured to track status of leads generated through online advertisements. The tracking system 112 enable the plurality of publishers 104 to track status of leads generated through online advertisements in real time. The tracking system 112 tracks the conversion process to ensure validation of leads. The tracking system 112 enables association of plurality of advertisement platforms 106 of the plurality of publishers 104 with one or more customer management platforms 110 of the plurality of advertisers 108. The tracking system 112 enables the plurality of publishers 104 to access status of lead generated through online advertisements in the one or more customer management platforms 110 of the plurality of advertisers 108.

The tracking system 112 is associated with at least one advertisement platform of the plurality of advertisement platforms 106. The tracking system 112 tracks the one or more users 102 clicking on advertisements published on the plurality of advertisement platforms 106. Each of the one or more users 102 clicks on advertisement published on an advertisement platform of the plurality of advertisement platforms 106. The tracking system 112 records the advertisement platform of the plurality of advertisement platforms 106 for each of the one or more users 102 clicking on the advertisement. The tracking system 112 records the advertisement platform of the plurality of advertisement platforms 106 for lead generated through digital advertisements.

The tracking system 112 is integrated with the one or more customer management platforms 110 of at least one advertiser of the plurality of advertisers 108. The one or more customer management platforms 110 facilitate in management of the conversion process of leads generated through online advertisements. The tracking system 112 enable the plurality of publishers 104 to access status of lead generated through online advertisements on the one or more customer management platforms 110. The tracking system 112 enable the plurality of publishers 104 to access status of leads on the one or more customer management platforms 110 of the plurality of advertisers 108 in real time. In an embodiment of the present disclosure, the tracking system 112 is integrated with any suitable platform of the plurality of advertisers 108.

The tracking system 112 classifies one or more stages in the conversion process of leads generated through online advertisements. The tracking system 112 classify one or more stages in the conversion process of leads with assent of corresponding publisher of the plurality of publishers 104 and corresponding advertiser of the plurality of advertisers 108. The tracking system 112 classifies one or more stages in the conversion process of leads to facilitate the plurality of publishers 104 in precisely and transparently billing the plurality of advertisers 108. Each of the one or more stage includes one or more steps of the conversion process. In pay-per-action the plurality of advertisers 108 agrees to pay the plurality of publishers 104 pre-defined amount corresponding to each stage of the conversion process. The tracking system 112 enables the plurality of publishers 104 to objectively and precisely bill the plurality of advertisers 108.

The tracking system 112 assigns a unique identification number to leads generated through online advertisements. The tracking system 112 assigns the unique identification number to each click on online advertisements by the one or more users 102. The tracking system 112 tracks status of lead generated through online advertisements in the one or more stages in conversion process. The tracking system 112 tracks the status of lead generated though online advertisements against the unique identification number. The tracking system 112 enables the plurality of advertisers 108 to track performance of the plurality of publishers 104. The tracking system 112 enables corresponding publisher of the plurality of publishers 104 to track status of lead generated through online advertisements in real time. Each of the plurality of click by the one or more users 102 is on advertisement publishing on an advertisement platform of the plurality of advertisement platforms 106 of a publisher of the plurality of publishers 104. The tracking system 112 stores details of the advertisement platform of the plurality of advertisement platforms 106 and details of the publisher of the plurality of publishers 104 against each click and the corresponding unique identification number.

The tracking system 112 enables each of the plurality of advertisers 108 to attribute leads generated through online advertisements to corresponding publisher of the plurality of publishers 104. The tracking system 112 enables the plurality of advertisers 108 to accurately distribute payment based on performance of leads generated through online advertisements among the plurality of publishers 104. The tracking system 112 facilitates each of the plurality of publishers 104 to enable performance based advertisement. The tracking system 112 prompts or promotes the plurality of publishers 104 to move from branded advertisements to performance based advertisements in order to generate more revenue. The tracking system 112 provides transparency in the conversion process to the plurality of publishers 104 to move from branded advertisements to performance based advertisements. The tracking system 112 incentivizes the plurality of publishers 104 to move from branded advertisements to performance based advertisements.

The tracking system 112 updates corresponding publisher of the plurality of publishers 104 on progress of leads generated through online advertisements in the one or more stages of the conversion process. The tracking system 112 sends a notification to corresponding publisher of the plurality of publishers 104 on progress of leads generated through online advertisements in the one or more stages of the conversion process. The tracking system 112 updates the classification of the one or more stages in the conversion process of leads generated through online advertisements in real time. The tracking system 112 updates the classification of the one or more stages in the conversion process of leads generated through online advertisements with assent of corresponding publisher of the plurality of publishers 104 and corresponding advertiser of the plurality of advertisers 108.

For example, a user X clicks on an advertisement of an advertiser A displayed on an advertisement platform F associated with a publisher P. The advertiser A is associated with other publishers. The publisher P is associated with various advertisers. The advertiser employs a customer management platform M for management of leads generated through online advertisements. The advertiser A and the publisher P are associated with the tracking system. The user X is redirected from the advertisement platform F to an online platform of the advertiser A. The user X is a lead generated by the publisher P for the advertiser A. The user X is lead generated through online advertisements for the advertiser A. The customer management platform M initiates tracking status of the user X. The user X is a lead generated for the advertiser A with facilitation of advertisement platform F of publisher P. The advertiser A and the publisher P are engaged under pay-per-action pricing model. The advertiser A follow a conversion process to confirm whether the user X is a customer or not. The conversion process includes five stages. The advertiser A pays the publisher P a pre-agreed amount on successful clearance of each stage of the conversion process by the user X. The tracking system enables the publisher P to track real time status of the user X on the customer management platform M. The tracking system enables the advertiser A to attribute the user X to the publisher P. The tracking system enables the publisher P to precisely and transparently bills the advertiser A.

The interactive computing environment 100 further includes the server 114 and the database 116. The tracking system 112 is associated with the server 114. In general, the server 114 is a computer program or device that provides functionality for other programs or devices. The server 114 provides various functionalities, such as sharing data or resources among multiple clients, or performing computation for a client. However, those skilled in the art would appreciate that more number of tracking system 112 are connected to more number of servers 114. Furthermore, it may be noted that the server 114 includes the database 116. However, those skilled in the art would appreciate that more number of the servers 114 includes more numbers of databases. In an embodiment of the present disclosure, the tracking system 112 is located in the server 114. In another embodiment of the present disclosure, the tracking system 112 is connected with the server 114. In yet another embodiment of the resent disclosure, the tracking system 112 is a part of the server 114. The server 114 handles each operation and task performed by the tracking system 112. The server 114 stores one or more instructions for performing the various operations of the tracking system 112. The server 114 is located remotely from the one or more users 102. The server 114 is associated with an administrator. In general, the administrator manages the different components in the tracking system 112. The administrator coordinates the activities of the components involved in the tracking system 112. The administrator is any person or individual who monitors the working of the tracking system 112 and the server 114 in real time. The administrator monitors the working of the tracking system 112 and the server 114 through a communication device. The communication device includes the laptop, the desktop computer, the tablet, a personal digital assistant and the like.

The database 116 stores different sets of information associated with various components of the tracking system 112. In general, databases 116 are used to hold general information and specialized data, such as data of the one or more users 102, data associated with the plurality of publishers 104, data associated with plurality of advertisers 108, data associated with plurality of advertisement platforms 106, data associated with the one or more customer management platforms 110. The databases 116 include data of advertisements and data of leads generated through online advertisements. The database 116 organizes the data using model such as relational models or hierarchical models.

The tracking system 112 may be implemented using a single computing device, or a network of computing devices, including cloud-based computer implementations. The computing devices are preferably server class computers including one or more high-performance computer processors and random access memory, and running an operating system such as LINUX or variants thereof. The operations of the tracking system 112 as described herein can be controlled through either hardware or through computer programs installed in non-transitory computer readable storage devices such as solid state drives or magnetic storage devices and executed by the processors to perform the functions described herein. The database is implemented using non-transitory computer readable storage devices, and suitable database management systems for data access and retrieval. The tracking system 112 includes other hardware elements necessary for the operations described herein, including network interfaces and protocols, input devices for data entry, and output devices for display, printing, or other presentations of data. Additionally, the operations listed here are necessarily performed at such a frequency and over such a large set of data that they must be performed by a computer in order to be performed in a commercially useful amount of time, and thus cannot be performed in any useful embodiment by mental steps in the human mind.

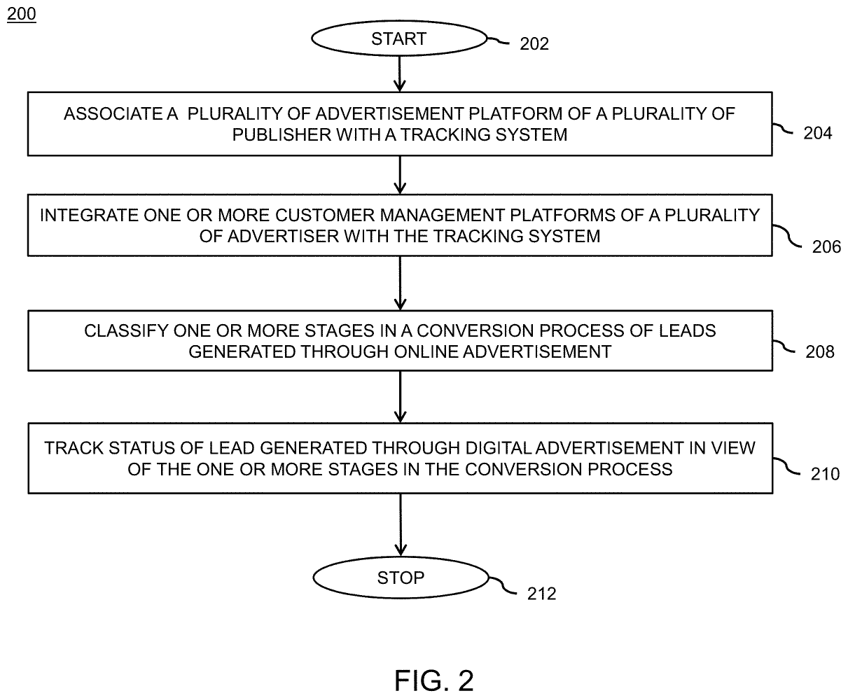

FIG. 2 is a flowchart 200 of a method for tracking of the leads generated through the online advertisements in real, in accordance with various embodiments of the present disclosure. It may be noted that to explain the process steps of the flowchart 200, references will be made to the system elements of FIG. 1. The flowchart 200 initiates at step 202. Following step 202, at step 204 the tracking system 112 associates the plurality of advertisement platforms 106 of the plurality of publishers 104. At step 206, the tracking system 112 integrates the one or more customer management platforms 110 of the plurality of advertisers 108. At step 208, the tracking system 112 classifies one or more stages in the conversion process of leads generated through online advertisements. At step 210 the tracking system 112 track status of lead generated through digital advertisement in view of the one or more stages in the conversion process. The flow chart 200 terminates at step 212.

It may be noted that the flowchart 200 is explained to have above stated process steps; however, those skilled in the art would appreciate that the flowchart 200 may have more/less number of process steps which may enable all the above stated embodiments of the present disclosure.

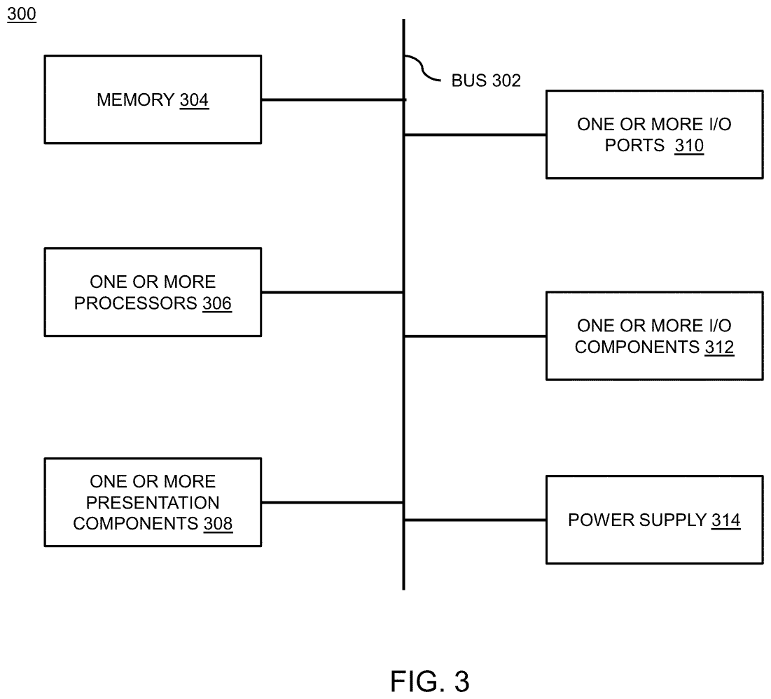

FIG. 3 illustrates the block diagram of a computing device 300, in accordance with various embodiments of the present disclosure. The computing device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary computing device 300 that can be used in connection with one or more embodiments of the present invention. Distinction is not made between such categories as “workstation,” “server,” “laptop,” “hand-held device,” etc., as all are contemplated within the scope of FIG. 3 and reference to “computing device.”

The computing device 300 typically includes a variety of computer-readable media. The computer-readable media can be any available media that can be accessed by the computing device 300 and includes both volatile and nonvolatile media, removable and non-removable media. By way of example, and not limitation, the computer-readable media may comprise computer readable storage media and communication media. The computer storage media includes volatile and nonvolatile, removable and non-removable media implemented in any method or technology for storage of information such as computer-readable instructions, data structures, program modules or other data. The computer storage media includes, but is not limited to, non-transitory computer-readable storage medium that stores program code and/or data for short periods of time such as register memory, processor cache and random access memory (RAM), or any other medium which can be used to store the desired information and which can be accessed by the computing device 300. The computer storage media includes, but is not limited to, non-transitory computer readable storage medium that stores program code and/or data for longer periods of time, such as secondary or persistent long term storage, like read only memory (ROM), EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 300.

The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media. The computing device 300 includes one or more processors that read data from various entities such as the memory 304 or I/O components 312. The one or more presentation components 308 present data indications to a user or other device. Exemplary presentation components include a display device, speaker, printing component, vibrating component, etc. The one or more I/O ports 310 allow the computing device 300 to be logically coupled to other devices including the one or more I/O components 312, some of which may be built in. Illustrative components include a microphone, joystick, game pad, satellite dish, scanner, printer, wireless device, etc.

The present disclosure has numerous disadvantages over the prior art. The present disclosure provides a novel method to detect any new advertisement running for the first time on any television channel. The advertisements are detected robustly and dedicated supervised and unsupervised central processing unit (hereinafter “CPU”) are installed. Further, the present disclosure provides a method and system that is economic and provides high return of investment. The detection of each repeated advertisement on supervised CPU and each new advertisement on unsupervised CPU significantly saves processing power and saves significant time. The disclosure provides a cost efficient solution to a scaled mapping and database for advertisement broadcast.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer-implemented method for tracking status of leads generated through online advertisements on real time dynamic basis, the computer-implemented method comprising:
associating, at a tracking system with a processor, at least one advertisement platform of a plurality of advertisement platforms with the tracking system, wherein each of the plurality of advertisement platforms provides space for publishing of the online advertisements, wherein each of the at least one advertisement platform is associated with a publisher of a plurality of publishers;
integrating, at the tracking system with the processor, one or more customer management platforms of at least one advertiser of a plurality of advertisers with the tracking system, wherein the one or more customer management platforms facilitate in management of a conversion process of leads generated through the online advertisements published on the at least one advertisement platform of the plurality of advertisement platforms;
classifying, at the tracking system with the processor, one or more stages in the conversion process of the leads generated through the online advertisements, wherein the classification of the one or more stages in the conversion process of the leads generated through the online advertisements is updated in real time; and
tracking, at the tracking system with the processor, status of the leads generated through the online advertisements in view of the one or more stages in the conversion process, wherein the tracking system tracks status of the leads generated through the online advertisements against a unique identification number,
wherein the tracking system enables each publisher of the plurality of publishers associated with the corresponding advertisement platform of the plurality of advertisement platforms to track status of the leads generated through the online advertisements in real time.

2. The computer-implemented method as recited in claim 1, further comprising assigning, at the tracking system with the processor, the unique identification number to each of one or more users performing a click on the online advertisements, wherein the tracking system stores details of each advertisement platform and the publishers against the unique identification number against each click and the corresponding unique identification number.

3. The computer-implemented method as recited in claim 1, wherein the tracking system with the processor updates corresponding publisher of the plurality of publishers on progress of the leads in the one or more stages of the conversion process.

4. The computer-implemented method as recited in claim 1, wherein the plurality of advertisement platforms of the plurality of publishers comprising a publisher website, a publisher application and a publisher e-mail.

5. The computer-implemented method as recited in claim 1, wherein the one or more customer management platforms of the plurality of advertisers comprising customer relationship management platform, a website and an application.

6. The computer-implemented method as recited in claim 1, wherein the tracking system enables the plurality of publishers to assess performance of advertisements to enable performance based advertisements.

7. The computer-implemented method as recited in claim 1, wherein the classification of the one or more stages in the conversion process is enabled with assent of the corresponding publisher of the plurality of publishers and the corresponding advertiser of the plurality of advertisers, wherein the classification of the one or more stages in the conversion process of the leads is updated with assent of the corresponding publisher of the plurality of publishers and the corresponding advertiser of the plurality of advertisers.

8. The computer-implemented method as recited in claim 1, wherein the tracking system facilitates corresponding publisher of the plurality of publishers to precisely bill the corresponding advertiser of the plurality of advertisers.

9. The computer-implemented method as recited in claim 1, wherein the tracking system enables each of the plurality of advertisers to attribute the leads to the corresponding publisher of the plurality of publishers.

10. A computer system comprising:
one or more processors; and
a memory coupled to the one or more processors, the memory for storing instructions which, when executed by the one or more processors, cause the one or more processors to perform a method for tracking status of leads generated through online advertisements on real time dynamic basis, the method comprising:
associating, at a tracking system, a plurality of advertisement platforms of a plurality of publishers, wherein each of the plurality of advertisement platforms provides space for publishing of online advertisements;
integrating, at the tracking system, one or more customer management platforms of a plurality of advertisers, wherein the one or more customer management platforms facilitate in management of a conversion process of leads generated through online advertisements;
classifying, at the tracking system, one or more stages in the conversion process of leads generated through online advertisements, wherein the classification of the one or more stages in the conversion process of leads generated through online advertisements is updated in real time; and
tracking, at the tracking system, status of the leads generated through the online advertisements in view of the one or more stages in the conversion process, wherein the tracking system tracks status of the leads generated through the online advertisements against a unique identification number,
wherein the tracking system enables each publisher of the plurality of publishers associated with the corresponding advertisement platform of the plurality of advertisement platforms to track status of the leads generated through the online advertisements in real time.

11. The computer system as recited in claim 10, further comprising assigning, at the tracking system with the processor, the unique identification number to each of one or more users performing a click on the online advertisements, wherein the tracking system stores details of each advertisement platform and the publishers against the unique identification number.

12. The computer system as recited in claim 11, wherein the tracking system stores details of the advertisement platform of the plurality of advertisement platforms and details of the publisher of the plurality of publishers against each click and the corresponding unique identification number.

13. The computer system as recited in claim 10, wherein the tracking system updates corresponding publisher of the plurality of publishers on progress of leads in the one or more stages of the conversion process.

14. The computer system as recited in claim 10, wherein the plurality of advertisement platforms of the plurality of publishers comprising a publisher website, a publisher application and a publisher e-mail.

15. The computer system as recited in claim 10, wherein the one or more customer management platforms of the plurality of advertisers comprising customer relationship management platform, a website and an application.

16. The computer system as recited in claim 10, wherein the tracking system enables the plurality of publishers to assess performance of advertisements to enable performance based advertisements.

17. The computer system as recited in claim 10, wherein the classification of the one or more stages in the conversion process is enabled with assent of the corresponding publisher of the plurality of publishers and the corresponding advertiser of the plurality of advertisers, wherein the classification of the one or more stages in the conversion process of leads is updated with assent of the corresponding publisher of the plurality of publishers and the corresponding advertiser of the plurality of advertisers.

18. The computer system as recited in claim 10, wherein the tracking system facilitates the corresponding publisher of the plurality of publishers to precisely bill the corresponding advertiser of the plurality of advertisers.

19. The computer system as recited in claim 10, wherein the tracking system enables each of the plurality of advertisers to attribute the leads to the corresponding publisher of the plurality of publishers.

20. A non-transitory computer-readable medium having instructions that, in response to execution of the instructions by one or more processors, cause the one or more processors to perform a method for tracking status of leads generated through online advertisements on real time dynamic basis, the method comprising:
associating, at a computing device, a plurality of advertisement platforms of a plurality of publishers, wherein each of the plurality of advertisement platforms provides space for publishing of online advertisements;
integrating, at the computing device, one or more customer management platforms of a plurality of advertisers, wherein the one or more customer management platforms facilitate in management of a conversion process of leads generated through online advertisements;
classifying, at the computing device, one or more stages in the conversion process of leads generated through online advertisements, wherein the classification of the one or more stages in the conversion process of leads generated through online advertisements is updated in real time; and
tracking, at the computing device, status of the leads generated the through online advertisements in view of the one or more stages in the conversion process, wherein the tracking system tracks status of the leads generated through the online advertisements against a unique identification number,
wherein the tracking system enables each publisher of the plurality of publishers associated with the corresponding advertisement platform of the plurality of advertisement platforms to track status of the leads generated through the online advertisements in real time.
